(19) United States
(12) Patent Application Publication
(10) Pub. No.: US 2022/0074544 A1
(43) Pub. Date: Mar. 10, 2022

(54) FOLDABLE HANDHELD GIMBAL

(71) Applicant: SZ DJI TECHNOLOGY CO., LTD., Shenzhen (CN)

(72) Inventor: Tianfei ZHAO, Shenzhen (CN)

(21) Appl. No.: 17/455,707

(22) Filed: Nov. 19, 2021

Related U.S. Application Data
(63) Continuation of application No. PCT/CN2019/088595, filed on May 27, 2019.

(51) Int. Cl. F16M 13/04; F16M 11/04; F16M 11/18; F16M 11/10; F16M 11/38; F16M 11/20; H04M 1/04

(52) U.S. Cl. CPC F16M 13/04; F16M 11/041; F16M 11/18; F16M 2200/024; F16M 11/38; F16M 11/2064; H04M 1/04; F16M 11/105

(57) ABSTRACT

A foldable handheld gimbal includes a handle having a rod shape, a first motor arranged at the handle and configured to drive a load to rotate around a first motor shaft, a first connection bracket, a second motor connected to another end of the first connection bracket and configured to drive the load to rotate around a second motor shaft, a second connection bracket with one end of the second connection bracket connected to the second motor, a third motor connected to another end of the second connection bracket and configured to drive the load to rotate around a third motor shaft, a carrier structure fixedly connected to a rotor of the third motor and configured to carry the load, and a hinge structure. The second motor, the third motor, and the hinge structure are arranged at a same side of the handle.

### CROSS-REFERENCE TO RELATED APPLICATION

This application is a continuation of International Application No. PCT/CN2019/088595, filed May 27, 2019, the entire content of which is incorporated herein by reference.

### TECHNICAL FIELD

The present disclosure relates to the field of gimbal technology and, more particularly, to a foldable handheld gimbal.

### BACKGROUND

When a handheld photographing device such as a mobile phone is used for shooting videos or images, the user's body or arm is easy to shake. As such, shaking or blurry may occur in the captured images. Therefore, when the user uses the handheld photographing device for shooting, a handheld gimbal is usually used to fix the handheld photographing device, so as to adjust a shooting angle of the handheld photographing device and stabilize the handheld photographing device at the determined shooting angle. However, the current handheld gimbal is relatively large, and the size is the same in a working state and a non-working state, which is inconvenient for a user to carry and store, thereby affecting the user experience.

### SUMMARY

In accordance with the disclosure, there is provided a foldable handheld gimbal including a handle having in a rod shape, a first motor arranged at the handle and configured to drive a load to rotate around a first motor shaft, a first connection bracket with one end of the first connection bracket connected to the first motor, a second motor connected to another end of the first connection bracket and configured to drive the load to rotate around a second motor shaft, a second connection bracket with one end of the second connection bracket being connected to the second motor, a third motor connected to another end of the second connection bracket and configured to drive the load to rotate around a third motor shaft, a carrier structure fixedly connected to a rotor of the third motor and configured to carry the load, and a hinge structure hinged to the first motor and the first connection bracket. The first connection bracket is configured to rotate around a hinge joint of hinge structure to switch the handheld gimbal among a plurality including a folded state. The second motor, the third motor, and the hinge structure are arranged at a same side of the handle.

### BRIEF DESCRIPTION OF THE DRAWINGS

FIG. 1 is a schematic structural diagram of a handheld gimbal at an angle according to some embodiments of the present disclosure.

FIG. 2 is a schematic structural diagram of the handheld gimbal in FIG. 1 from another angle.

FIG. 3 is a schematic structural diagram of a load according to some embodiments of the present disclosure.

FIG. 4 is a schematic structural diagram of the handheld gimbal in FIG. 1, where a first connection bracket is folded about a hinge joint, and a third motor is not folded about a hinge joint.

FIG. 5 is a schematic structural diagram of the handheld gimbal in FIG. 4 from another angle.

FIG. 6 is a partially enlarged schematic diagram of handheld gimbal at A in FIG. 5.

FIG. 7 is a structural schematic diagram of the handheld gimbal in FIG. 1, where the first connection bracket and the third motor are folded about the hinge joints.

FIG. 8 is a schematic structural diagram of the handheld gimbal in FIG. 7 from another angle.

FIG. 9 is a partial structural diagram of the handheld gimbal according to some embodiments, showing a handle, a first motor, and a first hinge member.

FIG. 10 is a partial structural diagram of the handheld gimbal in FIG. 1, showing a second hinge member, the first connection bracket, a second motor, a second connection bracket, a second hinge structure, the third motor, and a carrier structure.

FIG. 11 is a partial cross-section view of the handheld gimbal according to some embodiments of the present disclosure, showing a first shaft assembly, the first hinge member, a second hinge member, and the first connection bracket.

FIG. 12 is a schematic structural diagram of a first lock member of the handheld gimbal in FIG. 11.

FIG. 13 is a schematic structural diagram of a second lock member of the handheld gimbal in FIG. 11.

FIG. 14 is a schematic structural diagram of a handheld gimbal according to some embodiments of the present disclosure, showing the handle, the first motor, the first hinge member, the first shaft assembly, the second hinge member, and the first connection bracket.

FIG. 15 is a partial cross-section view of the handheld gimbal according to some embodiments of the present disclosure, showing the first lock member, the first hinge member, and the second hinge member.

### DESCRIPTION OF REFERENCE NUMERALS

100, handheld gimbal; 110, handle; 111, handle body; 112, matching member; 121, first motor; 122, second motor; 123, third motor; 130, first connection bracket; 131, bracket body; 132, first curved surface; 133, second curved surface; 134, side portion; 140, second connection bracket; 150, carrier structure; 151, main body; 152, clamp member;

160, first hinge structure; 161, first hinge member; 1611, first connection hole; 162, second hinge member; 1621, second connection hole; 163, first shaft assembly; 1631, first lock mechanism; 16311, first limit hole; 16312, second elastic member; 16313, second limit hole; 16314, positioning member; 1632, first shaft; 1633, first lock member; 1634, second lock member; 1635, convex structure; 16351, highest point of convex; 16352, lowest point of convex; 1636, concave structure; 16361, lowest point of concave; 1637, first elastic member;

170, second hinge structure; 171, third hinge member; 1711, sub-hinge member; 172, fourth hinge member; 173, second shaft assembly; 180, accommodation space; 190, control assembly; 191, operation member;

200, load; 300, mobile phone; Y, first motor shaft; P, second motor shaft; R, third motor shaft.

### DETAILED DESCRIPTION OF THE EMBODIMENTS

Implementation manners of the present disclosure are described in detail. Embodiments of the described implementation manner are shown in drawings. The same or similar reference numerals indicate the same or similar elements or elements with the same or similar functions. The implementation manners described in conjunction with accompanying drawings are merely used to explain the present disclosure and should not be considered as a limitation to embodiments of the present disclosure.

In the description of embodiments of the present disclosure, orientational or positional relationship indicated by a term such as “center,” “longitudinal,” “transverse,” “length,” “width,” “thickness,” “up,” “down,” “front,” “back,” “left,” “right,” “vertical,” “horizontal,” “top,” “bottom,” “inner,” “outer,” “clockwise,” or “counterclockwise” is based on the orientational or positional relationship shown in the drawings, and is only used to facilitate the description of embodiments of the present disclosure and simplify the description, rather than indicating or implying that the device or element referred to must have a specific orientation and be constructed and operated in a specific orientation. Therefore, the terms should not be understood to limit embodiments of the present disclosure. In addition, the terms “first” and “second” are used for descriptive purposes only and should not be understood to indicate or imply relative importance or implicitly indicate the number of indicated technical features. Thus, a feature as associated with “first” and “second” may explicitly or implicitly include one or more of the feature. In the description of embodiments of the present disclosure, the meaning of “plurality” is two or more, unless otherwise specified.

According to some embodiments of the present disclosure, a handheld gimbal 100 includes a handle 110 and a stabilization gimbal structure connected to the handle 110. The stabilization gimbal structure includes a first motor 121, a second motor 122, a third motor 123, connection brackets, and hinge structures. The stabilization gimbal structure may be detachably connected to the handle 110. The stabilization gimbal structure may also be detachably connected to another carrier, such as an unmanned aerial vehicle (UAV), a vehicle, or a ground remote control vehicle, etc. The stabilization gimbal structure may be quickly connected to the above-described carrier, such that the stabilization gimbal structure may be switched between different carriers. For example, the stabilization gimbal structure may be switched between the UAV and the handle 110, or the stabilization gimbal structure may be switched between the ground remote control vehicle and the handle 110.

The handheld gimbal 100 provided by embodiments of the present disclosure includes a folding function, so that the handheld gimbal 100 may be switched between an unfolded state (also referred to as a “use state”) and a folded state (also referred to as a “storage state”). When the handheld gimbal is switched from the unfolded state to the folded state, each motor may be switched from a power-on mode to the power-off mode. Oppositely, when the handheld gimbal is switched from the folded state to the unfolded state, each motor may be switched from a power-off mode to the power-on mode. For example, when the handheld gimbal is switched from the unfolded state to the folded state, two connection brackets start to rotate relative to each other. When an angle between the extension directions of the two connection brackets is smaller than a certain angle, at least one of a first motor 121, a second motor 122, or a third motor 123 is switched from the power-on mode to the power-off mode.

The angle between the extension directions of the two connection brackets being smaller than a certain angle can be that the angle is smaller than 90°, 80°, 70°, or 45°, which is not limited here.

In some embodiments, at least one of the first motor 121, the second motor 122, or the third motor 123 being switched from the power-on mode to the power-off mode can be that only the first motor 121, the second motor 122, or the third motor 123 is switched from the power-on mode to the power-off mode, that two of the three motors, such as the first motor 121 and the second motor 122, the first motor 121 and the third motor 123, or the second motor 122 and the third motor 123, are switched from the power-on mode to the power-off mode, or that all the three motors are switched from the power-on mode to the power-off mode.

Thus, when the handheld gimbal is switched from the unfolded state to the folded state, one or more of the motors are directly switched from the power-on mode to the power-off mode. Similarly, when the handheld gimbal is switched from the folded state to the unfolded state, one or more of the motors are directly switched from the power-off mode to the power-on mode. As such, not only battery power of the handheld gimbal can be saved, but also the convenient operation of the handheld gimbal for the user can be facilitated.

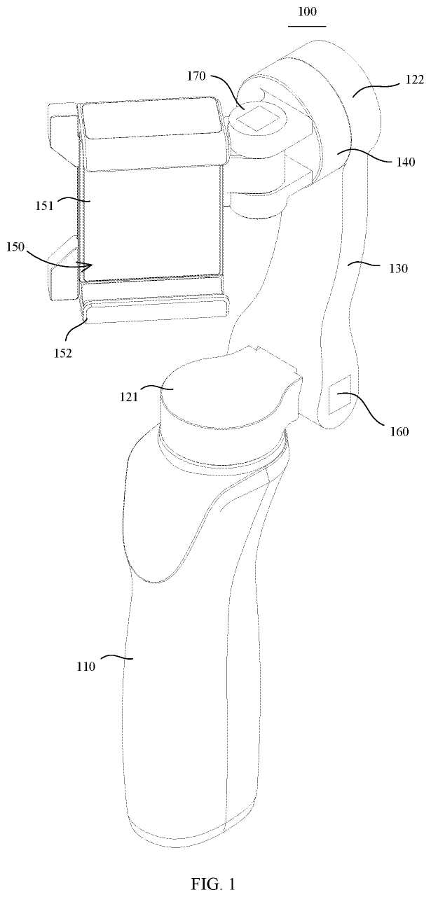

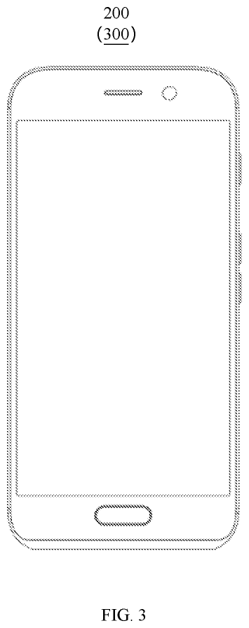

As shown in FIG. 1 to FIG. 8, embodiments of the present disclosure provide the foldable handheld gimbal 100. The foldable handheld gimbal 100 may be configured to carry a load 200, so as to adjust the position and orientation of the load 200, thereby meeting the work requirements of various scenarios. In some embodiments, the handheld gimbal 100 may also compensate for the vibration of the load 200 through rotation, so as to stabilize and balance the load 200. As such, the load 200 may work at a better attitude, thereby obtaining more accurate information.

In some embodiments, the load 200 may include one of an imaging device, a mobile terminal, or a sensor, etc. The imaging device may include a video camera, a camera, an ultrasound imaging device, an infrared (IR) imaging device, a camera lens, or other imaging devices. The mobile terminal may include a mobile phone, or a tablet, etc. The sensor may include an attitude sensor, such as an angle sensor, or an acceleration sensor, etc. In some embodiments, the imaging device may also include a mobile terminal, such as a mobile phone or a tablet computer with video recording and photographing functions, or another imaging device.

As shown in FIG. 1, in some embodiments of the present disclosure, a mobile phone 300 with video recording and photographing functions is taken as an example. Users may perform imaging work with the mobile phone 300 carried by the above-described handheld gimbal. The handheld gimbal stabilizes or controls the attitude of the mobile phone 300.

As shown in FIG. 1 to FIG. 8, in some embodiments, the handheld gimbal 100 includes the handle 110, the first motor 121, a first connection bracket 130, the second motor 122, a second connection bracket 140, the third motor 123, a carrier structure 150, and a first hinge structure 160.

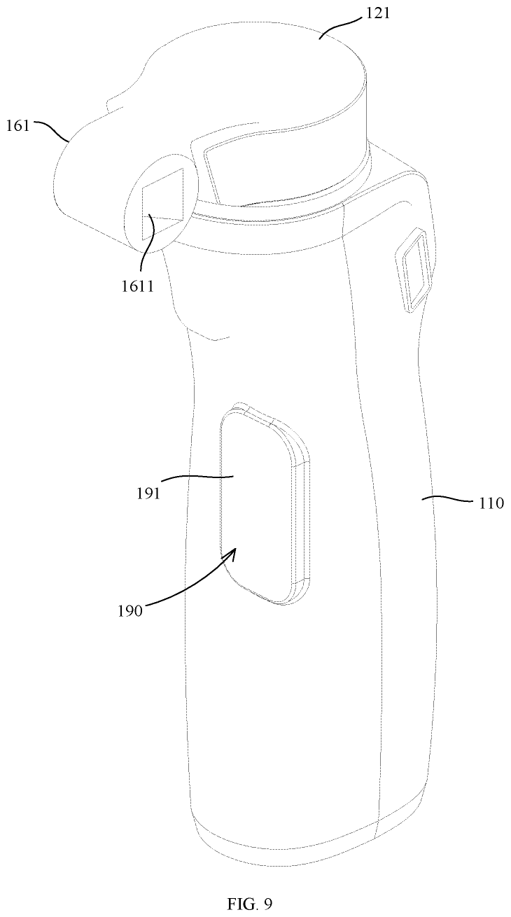

As shown in FIG. 9, the handle 110 is roughly in a vertical rod shape. The handle is configured to provide the user to hold and operate the handheld gimbal 100. The handle 110 includes a handle body 111 and a matching member 112. The handle body 111 is connected to the first motor 121. The matching member 112 is arranged at one side of the handle body 111. When the handheld gimbal 100 is in the folded state, the matching member 112 is configured to match the first connection bracket 130.

As shown in FIG. 1 to FIG. 8, in some embodiments, the first motor 121 is mounted at the handle 110. One end of the first connection bracket 130 is connected to the first motor 121. The second motor 122 is connected to the other end of the connection bracket 130. One end of the second connection bracket 140 is connected to the second motor 122. The third motor 123 is connected to another end of the second connection bracket 140. The first motor 121 is hinged with the first connection bracket 130 through the first hinge structure 160. When the handheld gimbal 100 is not in use, the first connection bracket 130 may be rotated around the hinge joint, so that the handheld gimbal 100 can be switched from the use state to the folded state. The second motor 122, the third motor 123, and the first hinge structure 160 are arranged at the same side of the handle 110, so that the entire volume of the handheld gimbal 100 can be reduced, as such, the handheld gimbal 100 occupies a small space, and is easy for users to store and carry, which improves the user experience.

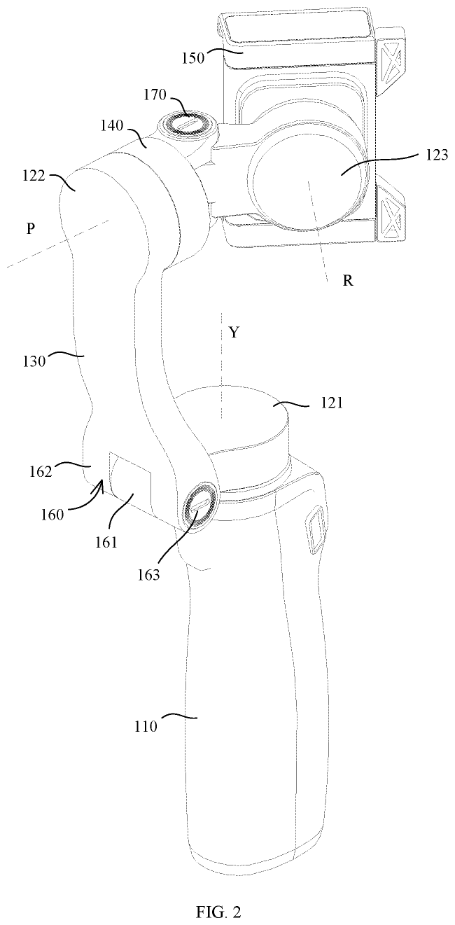

As shown in FIG. 1 and FIG. 2, the first motor is configured to drive the load 200 to rotate around a first motor shaft Y. In some embodiments, the handle 110 and the first connection bracket 130 are both connected to the first motor 121. One end of the first connection bracket 130 is connected to the first motor 121. The other end of the connection bracket 130 is connected to the second motor 122. In some embodiments, the handle 110 is connected to a stator of the first motor 121, and the first connection bracket 130 is connected to a rotor of the first motor 121. When the rotor of the first motor 121 rotates around the first motor shaft Y relative to the stator of the first motor 121, the first motor 121 may also drive the first connection bracket 130, the second motor 122, the second connection bracket 140, the third motor 123, and the load 200 to rotate around the motor shaft Y of the above-described handheld gimbal 100.

As shown in FIG. 1 to FIG. 8, the second motor 122 is configured to drive the load 200 to rotate around a second motor shaft P. In some embodiments, one end of the second motor 122 is connected to the first connection bracket 130. The other end of the second motor 122 is connected to the second connection bracket 140. One end of the second connection bracket 140 opposite to the second motor 122 is connected to the third motor 123. In some embodiments, the first connection bracket 130 is connected to a stator of the second motor 122, and the second connection bracket 140 is connected to a rotor of the second motor 122. When the rotor of the second motor 122 rotates relative to the stator of the second motor 122, the rotor of the second motor 122 may drive the second connection bracket 140, the third motor 123, and the load 200 to rotate around the second motor shaft P of the handheld gimbal 100.

As shown in FIG. 1 and FIG. 2, the third motor 123 is configured to drive the load 200 to rotate around the third motor shaft R. One end of the third motor 123 is connected to the second connection bracket 140. The other end of the second motor 123 may be directly connected to the carrier structure 150. The carrier structure 150 is configured to carry and fix the load 200. The carrier structure 150 is fixedly connected to the rotor of the third motor 123. In some embodiments, the second connection bracket 140 may be connected to a stator of the third motor 123. The carrier structure 150 may be connected to a rotor of the third motor 123. When the rotor of the third motor 123 rotates relative to the stator of the third motor 123, the carrier structure 150 and the load 200 may rotate around the third motor shaft R of the handheld gimbal 100.

As shown in FIG. 1 to FIG. 8, in some embodiments, the carrier structure 150 is configured to carry the mobile terminal with an imaging function, such as a mobile phone 300. The carrier structure 150 may be a clamp structure. In some embodiments, the carrier structure 150 includes a main body 151 and a clamp member 152. The main body 151 is connected to the rotor of the third motor 123. The main body 151 is configured to abut against a back of the mobile phone 300. The clamp member 152 is configured to fix the mobile phone 300 to the main body 151. To facilitate the mounting of mobile phone 300 with different sizes, the clamping size of the clamp member 152 may be adjusted according to practical needs. For example, the clamp member 152 includes two oppositely arranged movable clamps to help to clamp the mobile phone 300. In some embodiments, the clamping size of the clamp member 152 may be adjusted via the cooperation of, e.g., gears and racks. In some embodiments, the carrier structure 150 may also include oppositely arranged sliding grooves (not shown), so as to facilitate the mobile phone 300 to be mounted to the carrier structure via the sliding grooves.

In some embodiments, the carrier structure 150 may also include an imaging device, such as an imaging lens, or a camera with lens, etc. Take the imaging lens as an example, in some embodiments, the carrier structure 150 includes a movable part and a fixed part. The movable part and the fixed part are rotatably connected, as such, the movable part may be moved toward the fixed part or separated from the fixed part. The closure or the separation between the movable part and the fixed part may be implemented through a lock member, such as a snap-lock structure. The shape of the movable part and the fixed part match the imaging lens. When the movable part closes with the fixed part, the imaging lens may be locked to be fixed at the handheld gimbal 100. When the imaging lens needs to be removed, the lock member is operated to make the movable part separate from the fixed part, thereby loosening the imaging lens to facilitate the removal of the lens from the handheld gimbal 100. Further, the imaging lens may be a square lens, a circular lens, or an irregular shape lens, etc. In addition, the size and model of the imaging lens may also be selected according to the user's needs and is not limited here.

In some embodiments, the load 200 may swing around the first motor shaft Y, the second motor shaft P, and the third motor shaft R. As such, the handheld gimbal 100 may stabilize or control the attitude of the load 200 in three different axial directions, such that the load 200 may be maintained in better and more working states.

As shown in FIG. 1 and FIG. 2, in some embodiments of the present disclosure, the first motor 121 may be a yaw motor, and the first motor shaft Y is a yaw motor shaft. The second motor 122 may be a pitch motor, and the second motor shaft P is a pitch motor shaft. The third motor 123 may be a roll motor, and the third motor shaft R is a roll motor shaft.

In some embodiments, the first motor shaft Y and the second motor shaft P are approximately perpendicular to each other, and the first motor shaft Y and the third motor shaft R are approximately perpendicular to each other, which means that an angle between the two motor shafts is 85°˜95°. The angle between the second motor shaft P and the third motor shaft R is an acute angle, for example, 50°. In some embodiments, the first motor shaft Y, the second motor shaft P, and the third motor shaft R may be arranged to be in any other suitable arrangement according to an actual application scenario, for example, the first motor shaft Y is non-orthogonal to the second motor shaft P.

In some embodiments, when the handheld gimbal 100 is in the folded state, an axis of the second motor shaft P is approximately perpendicular to the handle body 111. In some embodiments, an axis of the second motor shaft P and the handle body 111 may be arranged in any other suitable arrangement, for example, the axis of the second motor shaft P is non-orthogonal to the handle body 111.

In the above-described embodiments, the first motor 121 may control the attitude of the load 200 in the yaw direction, the second motor 122 may control the attitude of the load 200 in the pitch direction, and the third motor 123 may control the attitude of the load 200 in the roll direction. Thus, the handheld gimbal 100 may realize three-axis stabilization and attitude control for the load 200, such that the load 200 may be maintained in a better attitude.

The first motor shaft Y, the second motor shaft P, and the third motor shaft R are actual shafts of the handheld gimbal 100. The dotted lines shown in FIG. 2 are the axes of the first motor shaft Y, the second motor shaft P, and the third motor shaft R.

As shown in FIG. 1 to FIG. 8, in some embodiments of the present disclosure, the first hinge structure 160 is hinged to the first motor 121 and the first connection bracket 130. The first hinge structure 160 allows the first connection bracket 130 to rotate relative to the first motor 121 between the unfolded state and the folded state. In some embodiments, other intermediate states may be set between the folded state and the unfolded. A rotation angle of the first connection bracket 130 about the hinge joint may be designed according to actual requirements. For example, the rotation angle of the first connection bracket 130 about the hinge joint is 135°˜215°. In an implementation manner, the rotation angle of the first connection bracket 130 may be 180°. In some other implementation manners, the rotation angle of the first connection bracket 130 may also be 135°, 215°, or any suitable angle between the two angles.

As shown in FIG. 1 and FIG. 2, when the handheld gimbal 100 is in the unfolded state, projection images of the second motor 122, the first hinge structure 160, and the third motor 123 on a longitudinal cross-section of the handle 110 are arranged in sequence. The longitudinal cross-section of the handle 110 refers to the cross-section in a length direction of the handle 110. That is, the projection images of the second motor 122, a first hinge member 161, and the third motor 123 on the longitudinal cross-section of the handle 110 are arranged in sequence. When the first connection bracket 130 rotates around the hinge joint to switch the handheld gimbal 100 from the use state to the folded state, the above-described structure may effectively reduce the overall volume of the handheld gimbal 100, making it easy for users to store and carry.

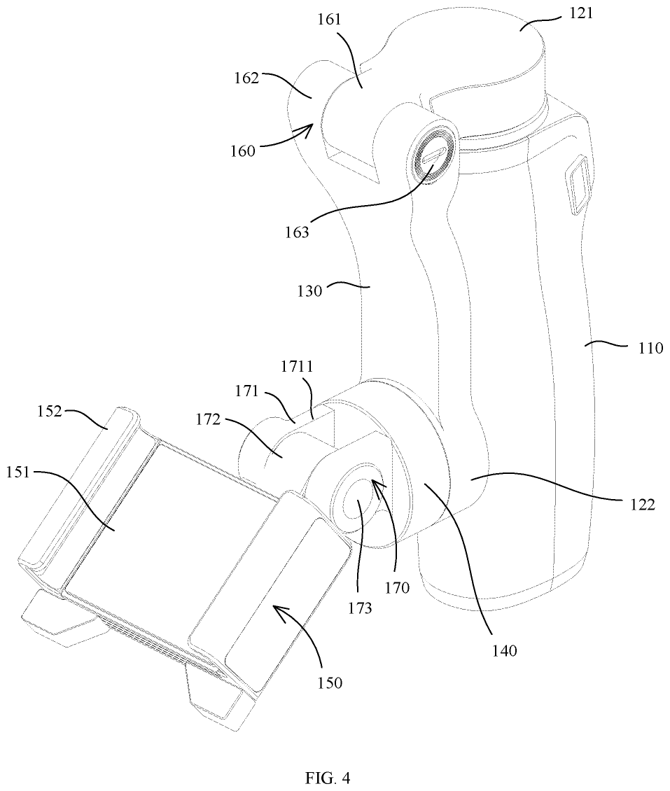

To effectively reduce the overall volume of the handheld gimbal 100, when the handheld gimbal 100 is in the folded state, the relative positions of the second motor shaft P and the third motor shaft R may be arranged in any suitable arrangement, so as to facilitate the user to store and carry. As shown in FIG. 4 to FIG. 8, when the handheld gimbal 100 is in the folded state, the angle between the axis of the second motor shaft P and the axis of the third motor shaft R is an acute angle, such as 50°.

As shown in FIG. 4 to FIG. 8, in some embodiments, when the handheld gimbal 100 is in the folded state, the axis of the second motor shaft P and the axis of the third motor shaft R are approximately parallel to each other, which means that the angle between the axis of the second motor shaft P and the axis of the third motor shaft R is 0°˜10°, for example, 0°, 10°, or any angle between the two.

As shown in FIG. 2 and FIG. 4, the first hinge structure 160 includes the first hinge member 161, a second hinge member 162, and a first shaft assembly 163. The first hinge member 161 extends outward from the outer periphery of the first motor 121. The second hinge member 162 extends from the first connection bracket 130 toward one end of the first motor 121. The first shaft assembly 163 is connected to the first hinge member 161 and the second hinge member 162. The first shaft assembly 163 is configured to hinge the first motor 121 and the first connection bracket 130.

In some embodiments, the first hinge member 161 extends outward from the side periphery of the first motor 121. Compared with scenarios in which the first hinge member 161 is arranged at other positions of the first motor 121, the above-described arrangement not only can allow the first hinge member 161 to cooperate with the second hinge member 162 to cause the first connection bracket 130 to rotate around the hinge point, but also can relatively reduce the overall volume of the handheld gimbal 100 in the folded state.

The first hinge member 161 and the second hinge member 162 may be arranged at any suitable position of the first shaft assembly 163, as long as the first hinge member 161, the second hinge member 162, and the first shaft assembly 163 can cooperate to realize the hinge connection of the first motor 121 and the first connection bracket 130. For example, the first hinge member 161 may be arranged at an end of the first shaft assembly 163, or the second hinge member 162 may be arranged at a middle of the first shaft assembly 163. As another example, the first hinge member 161 may be arranged at the middle of the first shaft assembly 163, and the second hinge member 162 may be arranged at the end of the first shaft assembly 163. As another example, the first hinge member 161 may be arranged at one end of the first shaft assembly 163, and the second hinge member 162 may be arranged at the other end of the first shaft assembly 163.

Any suitable number of the first hinge member 161 and the second hinge member 162 may be set according to actual needs. For example, the number of the first hinge member 161 is one and the number of the second hinge member 162 is two, and the two second hinge members 162 extend along the same end of the first connection bracket 130 at an interval. The two second hinge members 162 can be arranged at two ends of the first shaft assembly 163, respectively. The first hinge member 161 is arranged at a position at the middle or close to the middle of the first shaft assembly 163.

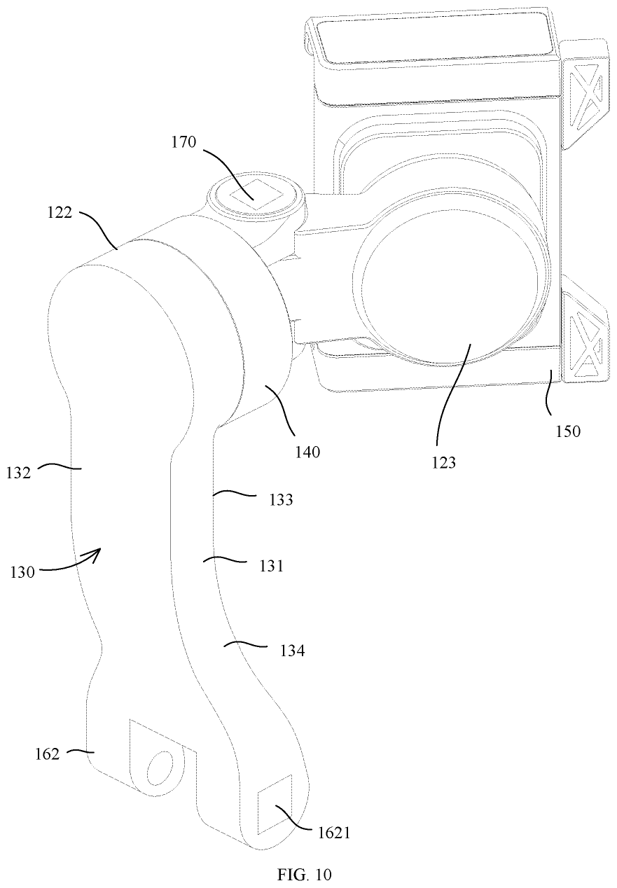

As shown in FIG. 9 and FIG. 10, a first connection hole 1611 is arranged at the first hinge member 161 along the axial direction of the first shaft assembly 163. A second connection hole 1621 is arranged at the second hinge member 162 along the axial direction of the first shaft assembly 163. The second connection hole 1621 matches the first connection hole 1611. The first shaft assembly 163 is arranged through the first connection hole 1611 and the second connection hole 1621 to hinge the first hinge member 161 and the second hinge member 162, as such, the first motor 121 and the first connection bracket 130 may be hinged to each other. The shape of the first connection hole 1611 and that of the second connection hole 1621 may be designed to be any suitable shapes, such as square holes, circular holes, other regular-shaped holes, or irregular-shaped holes, etc., as long as the designed holes match the first shaft assembly 163 to realize the hinge connection between the first motor 121 and the first connection bracket 130.

As shown in FIG. 1 to FIG. 8, in some embodiments of the present disclosure, the handheld gimbal 100 further includes a second hinge structure 170 hinged between the second connection bracket 140 and the third motor 123. The second hinge structure 170 can make the third motor 123 rotate relative to the second connection bracket 140 between the unfolded state and the folded state. In some embodiments, other intermediate states may be set between the folded state and the unfolded. A rotation angle of the third motor 123 about the hinge joint may be designed according to actual requirements. For example, the rotation angle of the third motor 123 about the hinge joint may be 100°˜150°. In an implementation manner, the rotation angle of the third motor 123 may be 130°. In some other implementation manners, the rotation angle of the third motor 123 may also be 100°, 150°, or any other suitable angle between the two angles.

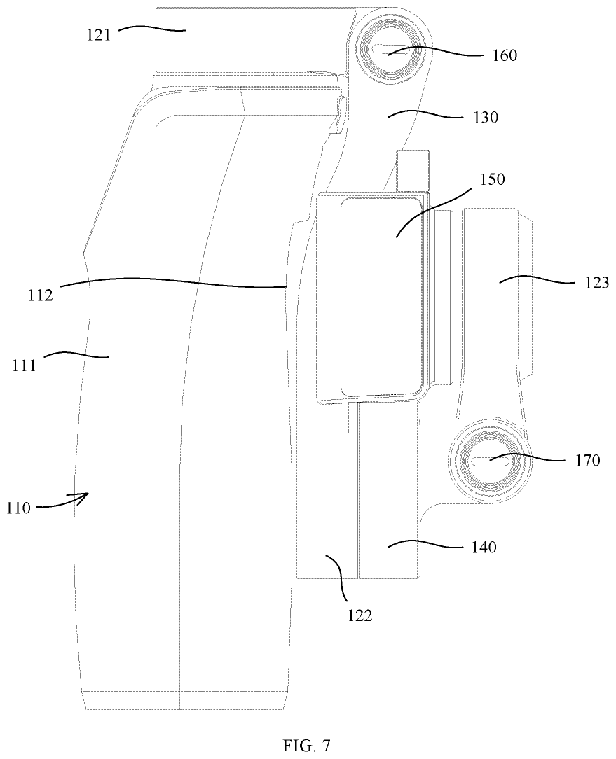

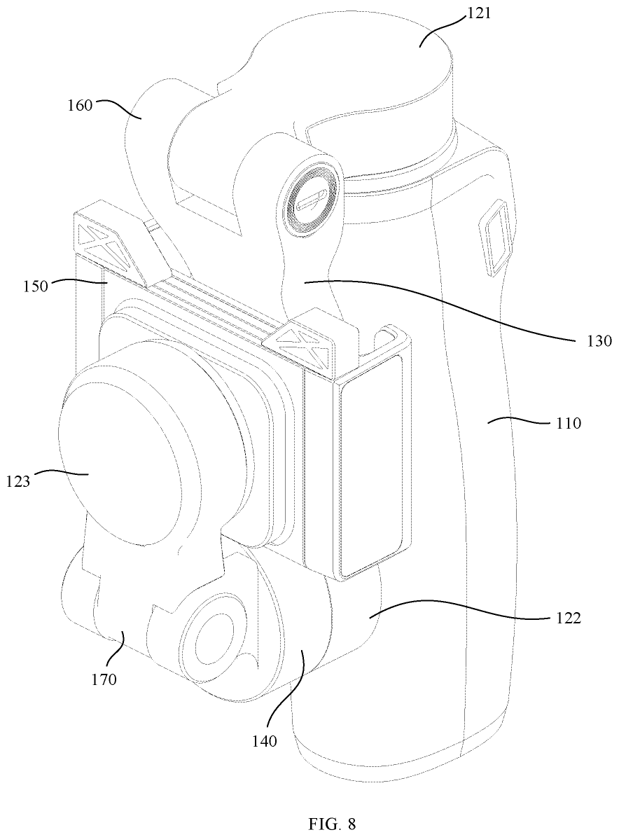

As shown in FIG. 7 and FIG. 8, in some embodiments, when the first connection bracket 130 and the third motor 123 rotate around the hinge to switch the handheld gimbal 100 from the unfolded state to the folded state, the carrier structure 150 is arranged between the handle body 111 and the third motor 123. In some embodiments, when the handheld gimbal 100 is in the folded state, the handle body 111, the carrier structure 150, and the third motor 123 are arranged in sequence along the axial direction of the third motor 123.

As shown in FIG. 4, in some embodiments, a second hinge structure 170 includes a third hinge member 171, a fourth hinge member 172, and a second shaft assembly 173. The third hinge member 171 extends from an end of the second connection bracket 140 away from the second motor 122. The fourth hinge member 172 extends outward from the outer periphery of the third motor 123. The second shaft assembly 173 is connected to the third hinge member 171 and the fourth hinge member 172, which is configured to hinge the second connection bracket 140 and the third motor 123.

The fourth hinge member 172 may extend outward from any suitable position on the outer periphery of the third motor 123, as long as the fourth hinge member 172 can be hinged with the third hinge member 171 and the second shaft assembly 173. For example, the fourth hinge member 172 extends outward from the side periphery of the third motor 123, and the fourth hinge member 172 corresponds to the position of the third hinge member 171 of the second connection bracket 140.

The third hinge member 171 and the fourth hinge member 172 may be arranged at any position of the second shaft assembly 173, as long as the third hinge member 171, the fourth hinge member 172, and the second shaft assembly 173 can cooperate to realize the hinge connection of the second connection bracket 140 and the third motor 123. For example, the third hinge member 171 may be arranged at an end of the second shaft assembly 173, and the fourth hinge member 172 may be arranged at a middle of the second shaft assembly 173. As another example, the third hinge member 171 may be arranged at the middle of the second shaft assembly 173, and the fourth hinge member 172 may be arranged at an end of the second shaft assembly 173. As another example, the third hinge member 171 may be arranged at one end of the second shaft assembly 173, and the fourth hinge member 172 may be arranged at the other end of the second shaft assembly 173.

As shown in FIG. 4, in some embodiments, the third hinge member 171 may be designed as any suitable structure, as long as the third hinge member 171 can cooperate with the fourth hinge member 172 to realize the hinge connection between the second connection bracket 140 and the third motor 123. For example, the third hinge member 171 includes one or more sub-hinge members 1711. The number of sub-hinge members 1711 may be any suitable value, for example, two, three, or more. When the number of the sub-hinge members 1711 is more than one, the plurality of sub-hinge members 1711 may be arranged at intervals along the axial direction of the second shaft assembly 173. In some embodiments, the sub-hinge member 1711 may protrude from the second connection bracket 140, and the sub-hinge member 1711 is hinged to the fourth hinge member 172, such that the second connection bracket 140 and the third motor 123 are hinged together.

In some embodiments, a structure of the second shaft assembly may be any suitable structure, as long as the third hinge member 171, the fourth hinge member 172, and the second shaft assembly 173 can cooperate to realize the hinge connection between the second connection bracket 140 and the third motor 123. In some embodiment, the structure of the second shaft assembly 173 is approximately the same as the structure of the first shaft assembly 163.

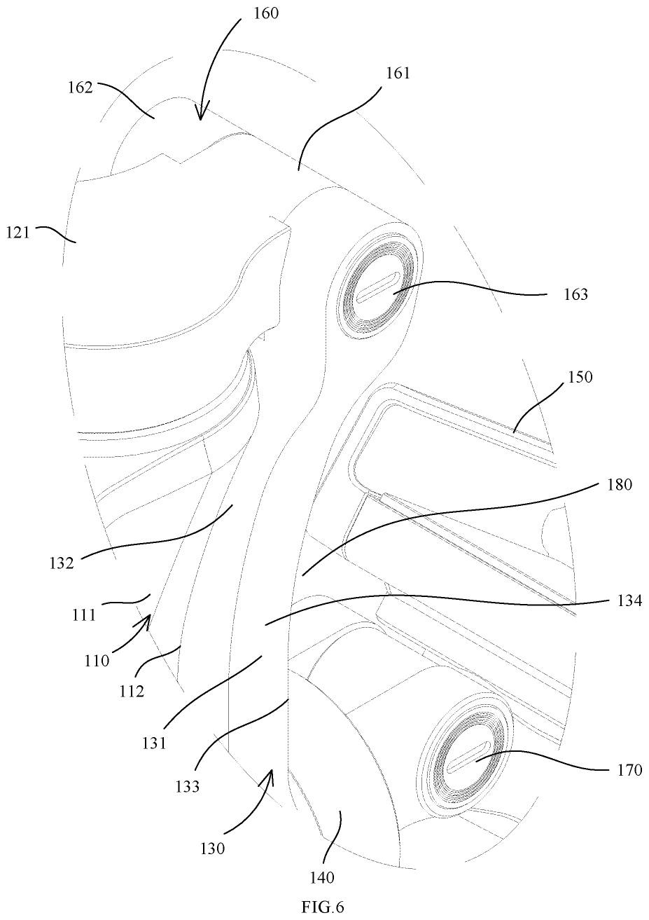

As shown in FIG. 6 and FIG. 10, the first connection bracket 130 includes a bracket body 131, a first curved surface 132, and a second curved surface 133.

Two ends of the bracket body are connected to the first motor 121 and the second motor 122, respectively. In some embodiments, the bracket body 131 is approximately in a long-stripe shape. In some embodiments, the bracket body 131 may be in any suitable shape, such as an L shape.

The first curved surface 132 is arranged on one side of the bracket body 131. The second curved surface 133 and the first curved surface 132 are arranged on both sides of the bracket body 131. In some embodiments, the second curved surface 133 and the first curved surface 132 are oppositely arranged at both sides of the bracket body 131. Bending directions of the second curved surface 133 and the first curved surface 132 are about the same. In some embodiments, the bending directions of the second curved surface 133 and the first curved surface 132 may also be different, as long as the first curved surface 132 can match the matching member 112 of the handle 110 when the handheld gimbal 100 is in the folded state.

In some embodiment, when the handheld gimbal 100 is in the folded state, the first curved surface 132 partially abuts against the handle 110. When the handheld gimbal 100 is in the folded state, the first curved portion 132 partially abuts against the matching member 112 of the handle 110. In some embodiments, when the handheld gimbal 100 is in a folded state, the first curved surface 132 and the handle 110 are arranged at an interval.

In some embodiments, when the handheld gimbal 100 is in the folded state, the matching member 112 at least partially abuts against the first curved surface 132. In some embodiments, the matching member 112 and the first curved surface 132 may also be arranged at an interval.

In some embodiments, the first connection bracket 130 further includes a side portion 134. The side portion 134 is connected to the first curved surface 132 and the second curved surface 133. The width of the first connection bracket 130 is smaller than the clamping width of the carrier structure 150, as such, when the handheld gimbal 100 is in the folded state, the clamp member 152 can be arranged at the side of the first connection bracket 130. The main body 151 of the carrier structure 150 and the second curved surface 133 are arranged to each other (that is, arranged face to face), thereby reducing the overall volume of the handheld gimbal 100 after being folded.

In some embodiments, when the handheld gimbal 100 is in the folded state, the carrier structure 150 at least partially abuts against the second curved surface 133. The main body 151 of the carrier structure 150 partially abuts against the second curved surface 133. The main body 151 and the second curved surface 133 may be arranged at an interval. The clamp member 152 of the carrier structure 150 may partially abut against or arranged at an interval from the side portion 134 of the first connection bracket 130. The clamp member 152 of the carrier structure 150 may partially abut against or arranged at an interval from the matching member 112 of the handle 110.

As shown in FIG. 6 to FIG. 8, in some embodiments, the second curved surface 133, the second motor 122, and the second connection bracket 140 enclose to form an accommodation space 180 to accommodate part of the carrier structure 150. As such, when the handheld gimbal 100 is folded, the carrier structure may be accommodated in the accommodation space 180, thereby reducing the overall volume of the handheld gimbal 100 and facilitating storage and carrying. In some embodiments, the carrier structure 150 may be partially accommodated in the accommodation space 180. The clamp member 152 may be arranged at the side portion 134 of the first connection bracket 130 to further reduce the overall volume of the handheld gimbal 100. In some embodiments, the accommodation space 180 may also be enclosed by a structure including the second curved surface 133 and the second connection bracket 140.

The second connection bracket 140 may be designed to have any suitable structure or shape. As shown in FIG. 1 to FIG. 8, and FIG. 10, the shape of the second connection bracket 140 is columnar. In some embodiments, the first connection bracket 130 and the second connection bracket 140 are approximately perpendicular to each other. In some embodiments, the first connection bracket 130 and the second connection bracket 140 may also be non-orthogonal to each other.

In some embodiments, a connection part of the first hinge member 161 and the first motor 121, the connection part of the second hinge member 162 and the first connection bracket 130, the connection part of the first connection bracket 130 and the second motor 122, the connection part of the second connection bracket 140 and the second motor 122, the connection part of the second connection bracket 140 and the third hinge member 171, the connection part of the fourth hinge member 172 and the third motor 123, and the connection part of the carrier structure 150 and the third motor 123 may be an integrated structure. As such, the number of parts can be reduced, thereby facilitating assembly and improving the production efficiency of the handheld gimbal 100.

In some embodiments, the connection part of the first hinge member 161 and the first motor 121, the connection part of the second hinge member 162 and the first connection bracket 130, the connection part of the first connection bracket 130 and the second motor 122, the connection part of the second connection bracket 140 and the second motor 122, the connection part of the second connection bracket 140 and the third hinge member 171, the connection part of the fourth hinge member 172 and the third motor 123, and the connection part of the bearing structure 150 and the third motor 123 may also be molded separately.

As shown in FIG. 9, the handheld gimbal 100 also includes a control assembly 190. The control assembly is configured to execute control functions to control the handheld gimbal 100 and/or the load 200. In some embodiments, the control assembly 190 includes an operation member 191 and a controller (not shown). The operation member 191 is arranged at the handle 110. The operation member 191 may be configured to receive input information. The controller may be arranged inside the handle 110. The controller may be configured to execute corresponding operations according to the input information.

Users may input information through the operation member 191. The controller controls the handheld gimbal 100 according to the input information, thereby changing the attitude of the load 200. For example, when using the handheld gimbal 100, the user may input information through the operation member 191 to determine a preset attitude of the load 200, so as to cause the load 200 to achieve the preset effect. The operation member 191 may also execute control functions to control the load 200, such as starting or stopping the photographing and recording, turning photo page, playing videos or photos, etc., which is convenient for users to use, thereby improving user experience.

When the handheld gimbal in the unfolded state shown in FIG. 1 or FIG. 2 needs to be switched to the folded state shown in FIG. 7 or FIG. 8, an external force is applied to cause the first connection bracket 130 to rotate around the first shaft assembly 163 in a direction toward the matching member 112 of the handle 110, so that the first connection bracket 130 may partially abut against the matching member 112. At this time, the first shaft assembly 163, the second motor 122, and the third motor 123 are arranged at the same side of the handle 110. The external force is further applied to cause the third motor 123 to rotate around the second shaft assembly 173 in the direction toward the second curved surface 133 of the first connection bracket 130 so that the main body 151 of the supporting structure 150 is arranged opposite to the second curved surface 133. The axis of the third motor 123 is approximately parallel to the axis of the second motor 122, and the handheld gimbal 100 is locked in the folded state. As such, the handheld gimbal 100 occupies a small space and has a compact structure.

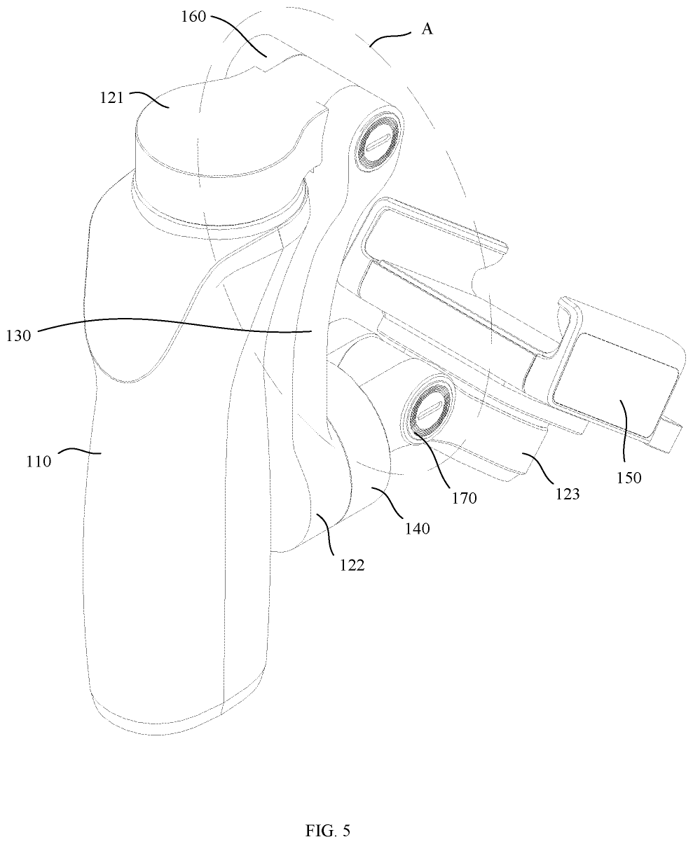

Referring to FIG. 4 and FIG. 5, in some embodiments, the above-described second hinge structure 170 may also be omitted. The first connection bracket 130 rotates around the hinge to switch the handheld gimbal 100 from the use state to the folded state. The first shaft assembly 163, the second motor 122, and the third motor 123 are arranged at the same side of the handle 110. In some embodiments, when the handheld gimbal 100 is switched from the use state to the folded state, an angle between the axis of the second motor shaft P and the axis of the third motor shaft R is an acute angle.

For the handheld gimbal 100 provided by the above-described embodiments, the first motor 121 is hinged to the first connection bracket 130. When the handheld gimbal 100 is not in use, the first connection bracket 130 may be rotated around the hinge, so that the handheld gimbal 100 may be switched from the use state to the folded state. The first shaft assembly 163, the second motor 122, and the third motor 123 are arranged at the same side of the handle 110, thereby reducing the overall volume of the handheld gimbal 100. As such, the handheld gimbal 100 occupies a small space, which is convenient for user to carry and store. thereby improving the user experience.

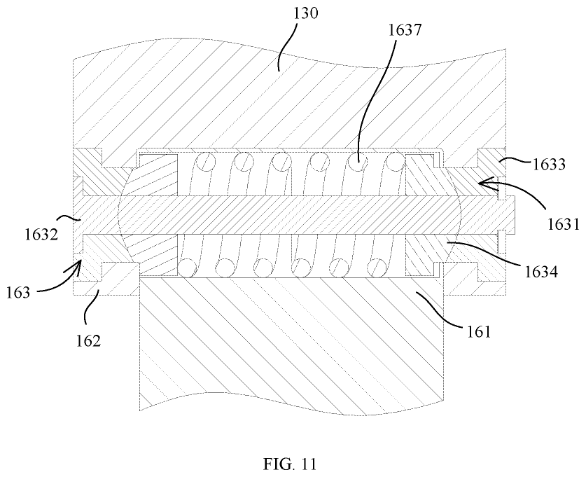

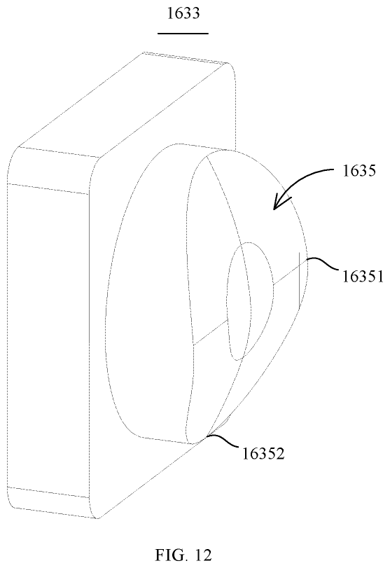

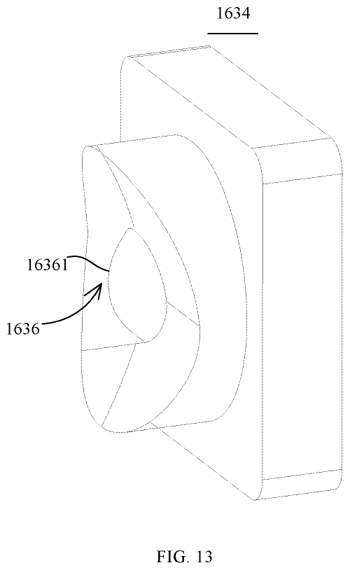

In some embodiments, as shown in FIG. 11 to FIG. 14, the first shaft assembly 163 includes a first lock mechanism 1631 and a first shaft 1632. The first lock mechanism 1631 is arranged between the first hinge member 161 and the second hinge member 162. The first lock mechanism 1631 is configured to lock the relative rotation between the first hinge member 161 and the second hinge member 162, so as to lock the first connection bracket 130 and the first motor 121 in the unfolded state or the folded state. The first shaft 1632 penetrates through the first lock mechanism 1631, and the first shaft 1632 penetrates through at least one of the first hinge member 161 or the second hinge member 162 to hinge the first motor 121 and the first connection bracket 130.

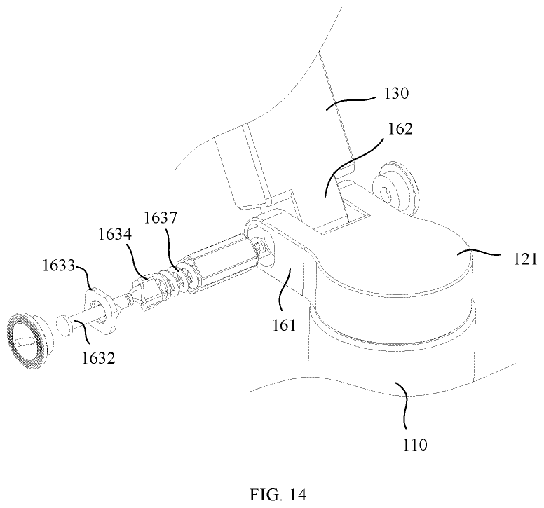

As shown in FIG. 11 and FIG. 14, the first connection bracket 130 is locked relative to the first motor 121 in any one of the folded state, the unfolded state, or other intermediate states. As such, the reliability of the handheld gimbal 100 may be improved. The first lock mechanism 1631 is also arranged between the first hinge member 161 and the second hinge member 162 to lock the first connection bracket 130 relative to the first motor. The first lock mechanism 1631 can lock the relative position of the first hinge member 161 and the second hinge member 162, so that the above-described handheld gimbal 100 may be maintained in a stable state described above. When the first lock mechanism 1631 is locked, the first hinge member 161 and the second hinge member 162 cannot rotate relative to each other. When the first lock mechanism 1631 is unlocked, the first hinge member 161 and the second hinge member 162 can rotate relative to each other.

In some embodiments, the first lock mechanism 1631 may be any suitable lock structure, as long as the first lock mechanism can lock the relative rotation between the first connection bracket 130 and the first motor 121. For example, the first lock mechanism 1631 may include at least one of an inclined plane lock structure, an eccentric lock structure, a four-bar lock structure, or a buckle lock structure.

As shown in FIG. 11 and FIG. 14, the first lock mechanism 1631 includes a first lock member 1633 and a second lock member 1634. The first lock member 1633 is arranged at the first hinge member 161. The second lock member 1634 is arranged at the second hinge member 162. The second lock member 1634 can cooperate with the first lock member 1633 to switch the first connection bracket 130 between the unfolded state and the folded state with respect to the first motor 121.

As shown in FIG. 11 to FIG. 13, at least one of the first lock member 1633 or the second lock member 1634 includes a convex structure 1635. When the first lock member 1633 and the second lock member 1634 rotate relative to each other, a distance between the first lock member 1633 and the second lock member 1634 is increased through the convex structure 1635. A contact point between the first lock member 1633 and the second lock member 1634 rotates along the convex structure 1635. When the contact point between the first lock member 1633 and the second lock member 1634 reaches the highest point of the convex structure 1635, the first connection bracket 130 is at a corresponding working state. When the contact point between the first lock member 1633 and the second lock member 1634 reaches the lowest point of the convex structure 1635, the first connection bracket 130 is at another working state. In some embodiments, the two working states of the first connection bracket 130 may be the folded state and the unfolded state, respectively.

As shown in FIG. 11 to FIG. 14, in some embodiments, the convex structure 1635 is arranged at the first lock member 1633. A concave structure 1636 matching the convex structure 1635 is arranged at the second lock member 1634. In some embodiments, a concave structure 1636 may be arranged at first lock member 1633. The convex structure 1635 matching the concave structure 1636 are arranged the second lock member 1634. The concave structure 1636 and the convex structure 1635 cooperate with each other to realize the cooperation of the first lock member 1633 and the second lock member 1634. When the first connection bracket 130 rotates relative to the first motor 121 through the first hinge structure 160, the second lock member 1634 may rotate around the first shaft 1632.

As shown in FIG. 11 and FIG. 14, the first lock mechanism 1631 may further include a first elastic member 1637. The first elastic member 1637 is arranged at the second lock member 1634. The first elastic member 1637 is configured to provide elastic force for the first lock member 1633 and the second lock member 1634. When the first connection bracket 130 is in the unfolded or folded state, an elastic moment of the first elastic member 1637 is not equal to zero, which can stabilize the first connection bracket 130 at the unfolded or the folded state, thereby avoiding the shaking of the first connection bracket of 130 and improving the connection reliability and stability of the first connection bracket 130, and ensuring the reliable operation of the handheld gimbal 100 within the folding range.

As shown in FIG. 11, in some embodiments, the number of the first lock member 1633 and the number of the second lock member 1634 are both two. The two second lock members 1634 abut against two of the first elastic member 1637, respectively. As such, the first connection bracket 130 may be further stabilized at the unfolded state or the folded state, thereby further improving the reliability and stability of the first connection bracket. In some embodiments, the number of the first lock member 1633 and the second lock member 1634 may be any suitable number. For example, the number of the first lock member 1633 and the second lock member 1634 may both be one. One end of a first elastic member 1637 abuts against the second lock member 1634, and the other end abuts against the second hinge member 162.

As shown in FIG. 11 to FIG. 13, in some embodiments, the convex structure 1635 includes two convex highest points 16351 and two convex lowest points 16352. The concave structure 1636 includes two concave lowest points 16361. The two convex highest points 16351 and the two concave lowest points 16361 form two dead point positions for the rotation of the first shaft 1632. In the above-described two positions, the concave structure 1636 and the convex structure 1635 can closely match each other to form the folded state or the unfolded state of the first connection bracket 130. In some embodiments, the line connecting the two convex highest points 16351 is approximately perpendicular to the line connecting the two concave lowest points 16352.

As shown in FIG. 14, the first lock mechanism 1631 may include a sleeve (not labeled) sleeved on the outside of the first elastic member 1637 and the first shaft 1632, and a clamping member (not labeled) for clamping and fixing the first rotating shaft 1632 on the first hinge member 161 or the second hinge member 162.

For the above-described handheld gimbal 100, the first connection bracket 130 may rotate relative to the first motor 121 between the unfolded position and the folded position. For the first connection bracket 130, during the switching process from the unfolded state or the folded state to the other, the first lock member 1633 and the second lock member 1634 rotate relative to each other. During the movement, the second lock member 1634 moves along the axial direction of the first shaft 1632, compresses the first elastic member 1637, causes the first elastic member 1637 to be elastically deformed, and generates elastic force. When the first lock member 1633 and the second lock member 1634 rotate for a certain angle and reach a matching angle, under the elastic force of the first elastic member 1637, the first lock member 1633 and the second lock member 1634 may tightly match each other. Then, the elastic force of the first elastic member 1637 keeps the first connection bracket 130 in the unfolded or folded state. Therefore, the above-described handheld gimbal 100 does not need to be locked manually, and the first connection bracket 130 can be fixed by only rotating the first connection bracket 130 in the unfolded state and the folded state,

In some embodiments, the convex structure 1635 may include a plurality of protrusions (not shown), and the concave structure 1636 may include a plurality of grooves (not shown) that cooperate with the protrusions. A bottom wall of a groove is an arc-shaped inclined surface, and a protrusion includes a matching surface (not shown) that matches the arc-shaped inclined surface. The contact point of the first lock member 1633 and the second lock member 1634 rotates around the arc-shaped inclined surface or the matching surface. When the contact point of the first lock member 1633 and the second lock member 1634 is arranged at the highest point of the matching surface, the first connection bracket 130 is at a certain working state. When the contact point of the first lock member 1633 and the second lock member 1634 is arranged at the lowest point of the matching surface, the first connection bracket 130 is at another working state.

In some embodiments, the plurality of protrusions may be arranged at intervals along the circumferential direction of the first shaft 1632. In some embodiments, the plurality of protrusions is arranged at equal intervals along the circumferential direction of the first shaft 1632. The number of protrusions may be two, three, four, or more.

The above-described handheld gimbal 100 may be switched between the folded state and the unfolded state. When the handheld gimbal 100 is in the folded state, the handheld gimbal 100 has a compact structure and occupies a small space, which is convenient for user to carry, thereby effectively improving the portability of the handheld gimbal 100. In addition, the first lock mechanism 1631 of the first shaft assembly 163 and the lock mechanism of the second shaft assembly 173 may lock the handheld gimbal at the folded or unfolded state, thereby improving the reliability of the handheld gimbal 100.

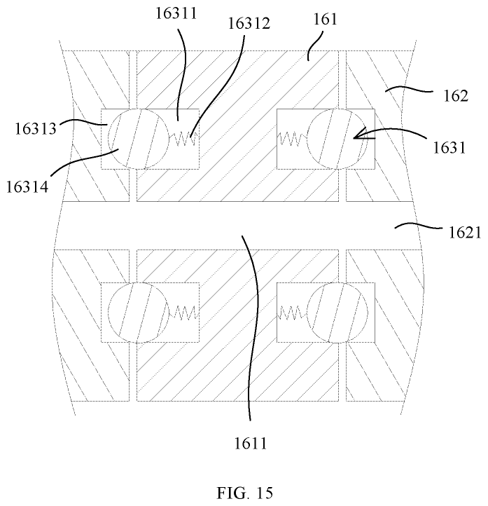

Another example of the handheld gimbal 100 will be described below in connection with FIG. 1 to FIG. 10, and FIG. 15, the structure of which is approximately the same as that of the above-described example handheld gimbal 100, except that the structure of the first lock mechanism 1631 is different, as shown in FIG. 15.

As shown in FIG. 15, the first lock mechanism 1631 includes a first limit hole 16311, a second elastic member 16312, a second limit hole 16313, and a positioning member 16314.

In some embodiments, the first limit hole 16311 is arranged at the first hinge member 161. The number of the first limit holes 16311 is two, and the two first limit holes 16311 are symmetrically arranged on the first hinge member 161 along the radial direction of the first shaft 1632. To facilitate manufacturing and improve the operability of the handheld gimbal 100, size and structure of the two first limit holes 16311 are approximately the same.

One end of the second elastic member 16312 abuts against the bottom wall of the first limit hole 16311, and the other end of the second elastic member 16312 abuts against the positioning member 16314. The second limit hole 16313 is arranged at the second hinge member 162 corresponding to the first limit hole 16311. The positioning member 16314 may be partially stored in the second limit hole 16313 under the action of the second elastic member 16312, thereby locking the relative rotation of a connection bracket 130 and the first motor 121. When the first connection bracket 130 rotates relative to the first motor 121 under the action of an external force, the positioning member 16314 may compress the second elastic member 16312, so that the positioning member 16314 may be separated from the second limit hole 16313, as such, the first connection bracket 130 and the first motor 121 may rotate relative to each other.

In some embodiments, the shape of the second limit hole 16313 and that of the positioning member 16314 may be any suitable shape, as long as they can cooperate to facilitate the positioning member 16314 to enter or leave the second limit hole 16313. For example, the shape of the positioning member 16314 may be spherical, and the second limit hole 16313 is a circular hole that matches the positioning member 16314. The number of the first lock mechanism 1631 may also be any suitable number, for example, one, two, or more. When the number of the first lock mechanism 1631 is more than one, the plurality of first lock mechanisms 1631 are arranged at intervals along the circumferential direction of the first shaft 1632 to further improve the reliability of the handheld gimbal 100.

The above-described handheld gimbal 100 may be switched between the folded state and the unfolded state. When the handheld gimbal 100 is in the folded state, the handheld gimbal 100 has a compact structure and occupies a small space, which is convenient for users to carry, thereby effectively improving the portability of the handheld gimbal 100. In addition, the first lock mechanism 1631 of the first shaft assembly 163 and the lock mechanism of the second shaft assembly 173 may lock the handheld gimbal 100 in the folded or unfolded state, thereby improving the reliability of the handheld gimbal 100.

In the description of the present disclosure, unless otherwise specified and defined, the terms “mount,” “connect,” or “connection” should be understood in a broad sense. For example, the connection may be a fixed connection, a detachable connection, or in one piece. The connection may further be a mechanical connection or an electrical connection. The connection may be a direct connection, or an indirect connection through an intermediate medium. The connection may also be an internal communication between two components or an interaction relationship between two components. For those of ordinary skill in the art, the specific meanings of the above terms in the present disclosure may be understood according to specific circumstances.

In embodiments of the present disclosure, unless otherwise specified and defined, a first feature being “above” or “below” a second feature may include the direct contact of the first and second features, or may include indirect contact of the first and second features through another feature therebetween. Moreover, a first feature being “above,” “on,” or “over” a second feature includes that the first feature is directly above or obliquely above the second feature, or simply means that the first feature is higher in level than the second feature. The first feature being “below,” “under,” or “beneath” a second feature includes that the first feature is directly under or obliquely under the second feature, or simply means that the first feature is lower in height than the second feature.

The present disclosure provides many various implementations or examples to implement different structures of embodiments of the present disclosure. To simplify embodiments of the present disclosure, components and settings of specific examples are described above. The description is merely exemplary and does not intend to limit embodiments of the present disclosure. Reference numerals and/or letters are repeated in different examples in embodiments of the present disclosure for simplicity and clarity, and do not indicate relationship among various implementations and/or settings. Embodiments of the present disclosure provide examples of various specific processes and materials, but those of ordinary skill in the art may be aware of application of other processes and/or use of other materials.

In this specification, description with the terms “one embodiment,” “certain embodiments,” “examples,” “specific examples,” or “some embodiments,” etc., means that specific features, structures, materials, or characteristics described in connection with embodiments or examples are included in at least one embodiment or example of the present disclosure. In the present disclosure, the schematic description of the above terms does not necessarily refer to a same embodiment or example. Moreover, the described specific features, structures, materials, or characteristics may be combined in any suitable manner in any one or more embodiments or examples.

Although implementation manners of the present disclosure are shown and described above. Those of ordinary skill in the art may understand that changes, modifications, replacements, and transformations can be made on above-described embodiments without departing from the principle and purpose of the present disclosure. The scope of the invention is defined by the claims and their equivalents.

What is claimed is:

1. A foldable handheld gimbal comprising:
a handle having a rod shape;
a first motor arranged at the handle and configured to drive a load to rotate around a first motor shaft;
a first connection bracket with one end of the first connection bracket connected to the first motor;
a second motor connected to another end of the first connection bracket and configured to drive the load to rotate around a second motor shaft;
a second connection bracket with one end of the second connection bracket connected to the second motor;
a third motor connected to another end of the second connection bracket and configured to drive the load to rotate around a third motor shaft;
a carrier structure fixedly connected to a rotor of the third motor and configured to carry the load; and
a hinge structure hinged to the first motor and the first connection bracket;
wherein the first connection bracket is configured to rotate around a hinge joint of the hinge structure to switch the handheld gimbal among a plurality of states including a folded state, in which the second motor, the third motor, and the hinge structure are arranged at a same side of the handle.

2. The foldable handheld gimbal according to claim 1, wherein when the handheld gimbal is in the folded state:
projections of the second motor, the third motor, and the hinge structure on a longitudinal cross-section of the handle are arranged in sequence.

3. The foldable handheld gimbal according to claim 2, wherein when the handheld gimbal is in the folded state:
an axis of the second motor shaft is approximately parallel to an axis of the third motor shaft; or
an included angle between the axis of the second motor shaft and the axis of the third motor shaft is an acute angle.

4. The foldable handheld gimbal according to claim 1, wherein the hinge structure includes:
a first hinge member extending outward from an outer periphery of the first motor;
a second hinge member extending from the first connection bracket toward the first motor; and
a shaft assembly connected to the first hinge member and the second hinge member, and configured to hinge connect the first motor and the first connection bracket.

5. The foldable handheld gimbal according to claim 4, wherein:
the first hinge member extends outward from a side periphery of the first motor;
the first hinge member is arranged at an end of the shaft assembly and the second hinge member is arranged at a middle of the shaft assembly;
the first hinge member is arranged at the middle of the shaft assembly and the second hinge member is arranged at the end of the shaft assembly; or
the first hinge member is arranged at one end of the shaft assembly and the second hinge member is arranged at another end of the shaft assembly.

6. The foldable handheld gimbal according to claim 4, wherein the shaft assembly includes:
a lock mechanism arranged between the first hinge member and the second hinge member and configured to lock a relative rotation between the first hinge member and the second hinge member, to lock the first connection bracket in an unfolded state or the folded state; and
a shaft penetrating at least one of the first hinge member or the second hinge member to hinge connect the first motor and the first connection bracket;

7. The foldable handheld gimbal according to claim 6, wherein the lock mechanism includes:
a first lock member arranged at the first hinge member;
a second lock member arranged at the second hinge member and configured to cooperate with the first lock member to enable the first connection bracket to switch with respect to the first motor among the plurality of states; and
an elastic member arranged at the first lock member and configured to provide an elastic force to the first lock member and the second lock member.

8. The foldable handheld gimbal according to claim 6, wherein:
the elastic member is a first elastic member; and
the lock mechanism further includes:
two first limit holes symmetrically arranged at the first hinge member or the second hinge member along a radial direction of the shaft;
a second elastic member, one end of the second elastic member abutting against at least one of the first limit holes;
a second limit hole arranged at the second hinge member or the first hinge member;
a positioning member abutting against another end of the second elastic member and partially received in the second limit hole, the positioning member being configured to compress the second elastic member to escape from the second limit hole when the first connection bracket rotates relative to the first motor.

9. The foldable handheld gimbal according to claim 4,
wherein the hinge structure is a first hinge structure;
wherein the shaft assembly is a first shaft assembly;
the handheld gimbal further comprising:
a second hinge structure hinge connected to the second connection bracket and the third motor, and including:
a third hinge member extending from one end of the second connection bracket that is away from the second motor;
a fourth hinge member extending outwards from an outer periphery of the third motor; and
a second shaft assembly connected to the third hinge member and the fourth hinge member, to hinge connect the second connection bracket and the third motor.

10. The foldable handheld gimbal according to claim 9, wherein:
the fourth hinge member extends outwards from a side periphery of the third motor;
the third hinge member is arranged at an end of the second shaft assembly, and the fourth hinge member is arranged at a middle of the second shaft assembly;
the third hinge member is arranged at the middle of the second shaft assembly, and the fourth hinge member is arranged at the end of the second shaft assembly; or
the third hinge member is arranged at one end of the second shaft assembly, and the fourth hinge member is arranged at another end of the second shaft assembly.

11. The foldable handheld gimbal according to claim 1, wherein the first connection bracket includes:
a bracket body, two ends of the bracket body being connected to the first motor and the second motor, respectively;
a first curved surface arranged at a side of the bracket body; and
a second curved surface arranged at another side of the bracket body, a bending direction of the second curved surface being approximately same as a bending direction of the first surface curved portion.

12. The foldable handheld gimbal according to claim 11, wherein the first curved surface is configured to abut against the handle when the handheld gimbal is in the folded state.

13. The foldable handheld gimbal according to claim 11, wherein a width of the first connection bracket is smaller than a clamping width of the carrier structure.

14. The foldable handheld gimbal according to claim 11, wherein the carrier structure is configured to partially abut against the second curved surface when the handheld gimbal is in the folded state.

15. The foldable handheld gimbal according to claim 11, wherein the second curved surface, the second motor, and the second connection bracket enclose to form an accommodation space to accommodate the carrier structure.

16. The foldable handheld gimbal according to claim 15, wherein the carrier structure is configured to be partially accommodated in the accommodation space when the handheld gimbal is in the folded state.

17. The foldable handheld gimbal according to claim 11, wherein the handle includes:
a handle body connected to the first motor; and
a matching member arranged at a side of the handle body.

18. The foldable handheld gimbal according to claim 17, wherein when the handheld gimbal is in the folded state:
the matching member abuts against a part of the first curved surface;
an axis of the second motor is approximately perpendicular to the handle body; or
the carrier structure is arranged between the handle body and the third motor.

19. The foldable handheld gimbal according to claim 1, wherein:
the first motor shaft includes a yaw motor shaft;
the second motor shaft includes a pitch motor shaft; and
the third motor shaft includes a roll motor shaft.

20. The foldable handheld gimbal according to claim 1, wherein:
a rotation angle of the first connection bracket about the hinge joint of the hinge structure is 135°˜215°; or
a rotation angle of the third motor about a hinge joint between the third motor and the second connection bracket is 100°˜150°.
